(19) United States
(12) Patent Application Publication
(10) Pub. No.: US 2024/0002741 A1
(43) Pub. Date: Jan. 4, 2024

(54) IMPROVEMENTS RELATING TO HYDROCARBON RECOVERY

(71) Applicants: Julian PARKER, Heswall, Merseyside (GB); Andre Dawson KRISTEN, Heswall, Merseyside (GB)

(72) Inventors: Julian PARKER, Heswall, Merseyside (GB); Andre Dawson KRISTEN, Heswall, Merseyside (GB)

(21) Appl. No.: 18/254,932

(22) PCT Filed: Nov. 30, 2020
(86) PCT No.: PCT/GB2020/053072

§ 371 Date: May 30, 2023

(30) Foreign Application Priority Data
Nov. 29, 2019 (GB) 1917435.8

(51) Int. Cl. C10L 3/10

(52) U.S. Cl. CPC C10L 3/10; C10L 2290/58; C10L 2290/48; C10L 2290/46; C10L 2290/30; C10L 2290/08; C10L 2290/547

(57) ABSTRACT

A process to extract work from raw high pressure hydrocarbon production fluids to power gas cleaning and contaminant disposal. This process takes raw high-pressure hydrocarbon well production fluids via pipeline, moderates the pressure through suppressor, separates the fluids into gaseous and liquid phases via separator, passes the gaseous phases through particle filter, then through liquid separator, then passes the gaseous phases through a work extraction machine to extract work. Work can rotate electrical generator, or a pump. Contaminants such as CO2 can be isolated using other cleaning plant, the pass via pipeline and disposed of subsurface via well/s and pipeline, with the pump running directly off the work extraction machine or separate pumps running off electricity generated by generator and distributed via cabling.

### FIELD

The present invention relates to processes to extract work from raw high pressure hydrocarbon production fluids to power gas cleaning and/or contaminant disposal.

### BACKGROUND

Fluid and gaseous hydrocarbon deposits can be found worldwide in a variety of geological contexts and often display unique chemistry within the hydrocarbons and non-hydrocarbons. Such hydrocarbon deposits can sometimes be found accumulated within porous geological structures called reservoirs from which the locally concentrated fluids and gases can be extracted via one or more well holes drilled so as to connect the surface to the reservoir. For hydrocarbon producers the most economically attractive hydrocarbon deposits are those that contain the most valuable hydrocarbon fractions and present the least technical problems for extraction, with the lowest levels of contaminants. Low contamination reservoirs and their contents are often referred to as sweet reserves by the hydrocarbon extraction industry.

Often the nature of the hydrocarbon deposit cannot be ascertained prior to drilling and it is only after drilling that the true economical value of any reservoir can be fully established. Factors that affect the economical viability of any deposit, beyond the actual hydrocarbons present, include all those factors that complicate the extraction and processing of the reservoir contents. Such factors include but are not limited to, elevated temperatures and pressures with the reservoir and the presence of contaminants within the produced hydrocarbons. After sampling of a newly confirmed reservoir, the decision is then made if it is economically viable to produce from the reservoir. In the past many hydrocarbon reservoirs have been passed over and production plans abandoned in favour of better targets, where the investment yield and production costs will offer more profit because the temperatures are lower and purity is higher.

However, as the value of hydrocarbons increase, and reserves deplete, then the economical viability of individual reservoirs can change. One class of reservoir that has traditionally been seen as less desirable from an economics perspective is sour reservoirs, also known as acid reservoirs. In this class of reservoir, the hydrocarbons are contaminated with compounds such as hydrogen sulfide and carbon dioxide or alone or as a combination of both. The presence of these compounds complicates production and they have to be removed at the surface for the hydrocarbons to have any economic value.

To clean away contaminants the hydrocarbons are passed through a process called sweetening which removes most of the unwanted contaminants. The contaminants can then be further processed into commercial products, or re-injected into the subsurface strata for storage or to aid in hydrocarbon recovery. There are several different methods to achieve sweetening of a hydrocarbon but regardless of the process used this cleaning process is always energy intensive. The expenditure of energy to extract unwanted and economically unattractive contaminants in turn lowers the economic yield and financial viability of the hydrocarbon deposit and increases the carbon footprint of any produced hydrocarbons when compared to sweeter deposits. Additionally, due to the highly corrosive nature of the contaminants in the gas, treatment local to the production site is often required.

In addition to contaminated hydrocarbon, some sour or acid deposits can present additional economic problems due to the temperature and pressure of the reservoir. Many such deposits can be classified as having higher internal pressure than normally encountered, or higher temperatures than normally encountered, or commonly both higher temperatures and higher pressures. These elevated reservoir conditions impact on the engineering remedies required to extract the hydrocarbons, which in turn also impacts further on the economical viability of the hydrocarbon deposit.

As global hydrocarbon deposits deplete and the monetary value of hydrocarbons increases, there are increasing financial and political incentives to exploit deposits that were previously dismissed as less desirable. In addition, some states are finding that because of worries over energy security; producing from domestic sour or acid reservoirs is increasingly attractive, despite the economic disadvantages. As outlined above there exist methods to extract and produce acid and sour hydrocarbons, and methods to treat the resultant hydrocarbons once recovered, however, the cost of the recovery and treatment is higher than sweeter, less problematic hydrocarbon reserves, both financially and in terms of the products carbon footprint. There is therefore a need to develop a method to offset the energy used in the extraction, treatment and waste disposal stages of successful production from sour gas reservoirs to make them more economically viable and to keep their production carbon footprint as low as possible. There is also an increasing social pressure to avoid the release of extracted CO2,which is currently the hydrocarbon industry standard practice with vast volumes being released daily from sour gas fields.

### SUMMARY

In accordance with an aspect of the present invention, there is provided a process for recovering energy in a natural gas production system comprising
Extracting natural gas from a subterranean natural gas reservoir
Passing said gas through an overpressure separator
Separating the liquid and gas phases
Filtering the gas phase stream to remove entrained solids
Drying the gaseous phase
Passing the gaseous phase through a work recovery engine to convert the high pressure, high temperature gaseous phase into lower pressure, lower temperature gaseous phase and thereby generate energy.

The present invention utilises the intrinsic potential and thermal energy contained within High Pressure High Temperature (HPHT) fluids found in, for example, sour gas fields and sweet gas fields. In known systems, energy is ‘lost’ across let down valves.

The subterranean natural gas reservoir preferably are high pressure, high temperature (HPHT) reservoirs. HPHT reservoirs typically have an initial reservoir pressure of about 10,000 psia (690 bara) and reservoir temperature of about 300° F. (149° C.). The present invention may also be employed with ultra HPHT reservoirs and/or those reservoirs having lower pressure and temperatures where there is a need for a blow out preventer.

The subterranean natural gas reservoir may have a pressure of at least 7500 psia and a temperature of at least 100° C.

The natural gas may be sweet gas or acid/sour gas. Sweet gas is natural gas with little to no contamination whilst acid/sour gas is natural gas also containing carbon dioxide or hydrogen sulphide although commonly both are found in contaminated reservoirs.

Natural gas may include any one or more of the following: hydrocarbons, methane, superhot brine, CO₂, supercritical water.

Super critical water may be a gas at surface pressure and gases like CO 2 can be in the high pressure liquid phase or even a solid.

The work recovery engine receives high pressure, high temperature fluids and delivers lower pressure, lower temperature fluids downstream and thereby generates energy that can be utilised in other systems.

The work recovery engine may comprise any means to convert changes in pressure into, for example, electrical energy.

The work recovery engine may comprise a turboexpander.

A turboexpander is essentially a centrifugal, or axial flow turbine, through which a high-pressure gas is expanded to produce work.

The expansion process is considered to be isentropic as work is being extracted from the process. This means that very low temperatures can be experienced downstream of the work recovery engine and these low temperatures are lower in comparison to cases when using a Joule Thomson (JT) valve type arrangement for comparable pressure ratios.

The work (or shaft power) created by the turboexpander unit may be used to either power a piggy-backed compressor (turboexpander) and/or to generate electricity (turbogenerator).

Preferably the process comprises the step of pre-treatment to remove solids and liquids from the inlet fluid stream. The presence of solids and/or liquids (above c. 5% vol/vol) may cause significant operational and integrity issues. These include erosion of the impeller, the inlet guide vane and the casing, as well as the potential of accumulation within the seals and behind the impeller.

Advantageously, there is filtration upstream of the work recovery engine to reduce any contaminant particles to a size of about 2-3 μm in diameter.

Advantageously, there is separation of liquids upstream of the work recovery engine to separate and/or reduce the volume of liquid droplets from the feed gas. Liquid droplets may cause deterioration of the expander efficiency, which will be accelerated by any erosion caused by liquids droplets in the feed gas.

In accordance with another aspect, there is provided a subterranean natural gas reservoir energy recovery system comprising:
an overpressure protector capable of being in fluid communication with a natural gas reservoir,
a separator for separating liquid phase from gaseous phase,
a filter system for separating entrained solids and comprising at least one filter unit cleaning the gaseous phase,
means for drying the gaseous phase,
at least one work recovery engine for recovering energy from the gaseous phase

The work recovery engine may receive high pressure, high temperature fluids and delivers lower pressure, lower temperature fluids downstream and thereby generates energy that can be utilised in other systems.

The components of the system may be successively in fluid communication with those components upstream and/or downstream.

The at least one work recovery engine may in turn be coupled to means for making use of the recovered energy.

The means for making use of the recovered energy may comprise a compressor pump, electrical generator, and/or geothermal engine.

The electricity produced may be utilised to clean the hydrocarbon gas and/or powering sequestration pumps for subsurface disposal of contaminants, such as carbon dioxide.

The work recovery engine may be in fluid communication with the production fluids conduit such that gaseous phase may be comingled therewith.

The comingled gaseous phase and liquid phase may pass to an ammonia cleaning plant in which hydrogen sulphide and carbon dioxide may be removed from the hydrocarbon gas phase.

Typically, an aqueous ammonia cleaning plant functions at a lower pressure than other gas cleaning plants allowing for, in an embodiment, the generation of more electricity, for example, from the process described hereinabove.

In an embodiment, the work recovery engine is coupled to a compressor pump to provide energy thereto and which may operate to pump carbon dioxide and/or other contaminants into substrata for sequestration or to compress hydrocarbon gas for LPG transportation.

In an embodiment, the work recovery engine is coupled to a cleaning plant in which hydrogen sulphide and carbon dioxide may be removed from the hydrocarbon gas phase. Carbon dioxide may be isolated and delivered to a sequestration pump which may itself be powered by electricity provided by an electricity generator upstream. The carbon dioxide may be transported deep underground.

The process of the present invention may reduce the energy costs and CO2 generation associated with the removal and further processing of H2S and CO2 from sour and acid hydrocarbon reservoirs, while providing energy to sequester underground any captured CO2 and any other unwanted contaminants rather than releasing them into the atmosphere. The invention, as described herewith, further provides the ability to produce new economically useful products if desirable. It is advantageous that the process of cleaning the hydrocarbon products for transport onwards from the field and all the ancillary processing of contaminants should be as much as possible be enabled by utilizing the physical properties of the downhole and producible reservoir contents to produce work that can in turn be used to run the plant and processes required without consuming any of the produced hydrocarbons.

Gases and fluids, including connate water, produced from an acid or sour gas reservoir can be significantly elevated in temperature and be under high pressure when compared to ambient surface conditions. This difference in temperature and pressure between reservoir and the inlet pressure required for cleaning predicts that there is considerable expansion potential for the produced fluids and gases. This expansion potential can therefore be harnessed to operate work recovery engines to extract work which can ultimately be used to generate electricity, as is widely achieved in combustion-based electricity generators. However, unlike combustion based electricity generation, in which the expansion is achieved by injecting and combusting a purified hydrocarbon, the production fluids/gas in a sour gas field are chemically aggressive, multiphase and can contain oil, water and sediments from the reservoir. Therefore, in order to extract any work the gas phase need to be separated and filtered while still retaining the expansion potential vital to produce work, but moderated to a pressure that the system can handle.

### BRIEF DESCRIPTION OF THE FIGURES

The invention will now be described solely by way of example and with reference to the accompanying drawings in which:

FIG. 1 shows the process in its stages with electricity production

FIG. 2 shows the process in its stages with electricity production and an aqueous ammonia gas cleaning plant

FIG. 3 shows the process in its stages with a compressor element for CO2 sequestration or LPG compression

FIG. 4 shows the process in its stages with electricity production, gas cleaning plant and sequestration of CO2, etc., separated from the hydrocarbons

FIG. 5 shows a turbo expander in accordance with the present invention

### DETAILED DESCRIPTION

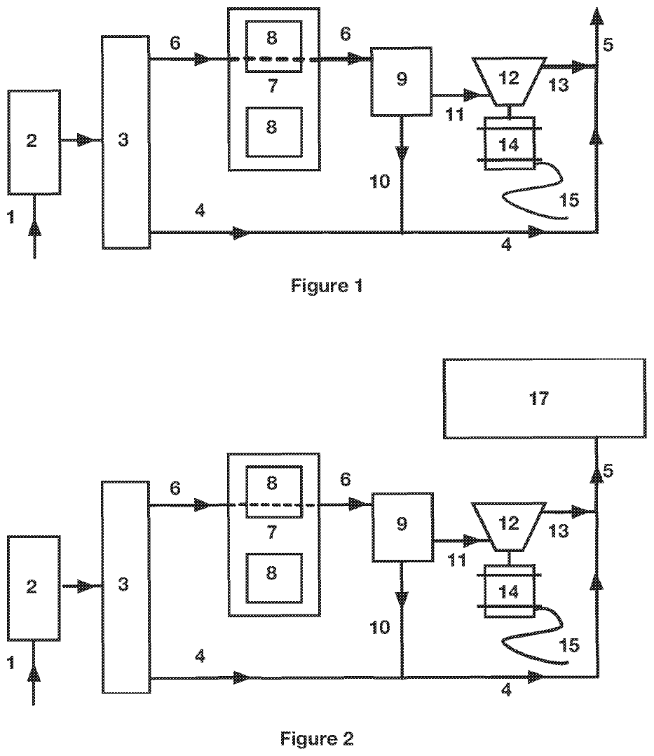

In FIG. 1, high pressure pipeline or 1 which carries the production flow from a gas well or wells drilled into a deep hydrocarbon reservoir, is connected to an overpressure protector 2 that sets the maximum fluid pressure that can pass beyond the protector 2 and limits the pressure to a pressure compatible with the next stages of the process. Overpressure protector 2 is connected by conduit to bulk separator 3 which crudely separates liquid phases from gaseous phases, liquid phases bypass the rest of the system via conduit 4 to be comingled later with the rest of the well production phases in pipeline 5. Gaseous phases pass onwards through conduit 6 into filter system 7 which removes entrained solids and has a plurality of selectable filter units 8 to allow for switching and cleaning without restricting the continuous flow of gaseous phases. The filtered gaseous phases then pass further down conduit 6 to a final separator 9 to ensure that the gaseous phases are completely dry. Any liquid phases separated out pass through conduit 10 to eventually connect with pipeline 5, in this illustration via connection with conduit 4. The dry and clean, high pressure gaseous phases pass through conduit 11 into one or more work recovery engines 12 before exiting into conduit 13 at a lower pressure than they entered. Conduit 13 connects to pipeline 5 to be comingled with the rest of the production fluids in pipe 5. Each work recovery engine 12 is connected to an electrical generator 14. Electricity produced passes down wire 15 and can be used for any purpose but cleaning the hydrocarbon gas and running sequestration pumps for subsurface disposal of contaminants like carbon dioxide is preferable. This entire process from wellhead to end runs at very high pressures, with high temperatures and can contain dangerous gases like H2S, CH4, etc., so safety is paramount. A plethora of control valves, isolation valves, pressure sensors, temperature sensors, level sensors, gas sensors and an emergency shutdown system (and electrification) is essential for safe operation but have been omitted for clarity in the illustrations.

In FIG. 2, high pressure pipeline or 1 which carries the production flow from a gas well or wells drilled into a deep hydrocarbon reservoir, is connected to an overpressure protector 2 that sets the maximum fluid pressure that can pass beyond the protector 2 and limits the pressure to a pressure compatible with the next stages of the process. Overpressure protector 2 is connected by conduit to bulk separator 3 which crudely separates liquid phases from gaseous phases, liquid phases bypass the rest of the system via conduit 4 to be comingled later with the rest of the well production phases in pipeline 5. Gaseous phases pass onwards through conduit 6 into filter system 7 which removes entrained solids and has a plurality of selectable filter units 8 to allow for switching and cleaning without restricting the continuous flow of gaseous phases. The filtered gaseous phases then pass further down conduit 6 to a final separator 9 to ensure that the gaseous phases are completely dry. Any liquid phases separated out, pass though conduit 10 to eventually connect with pipeline 5, in this illustration via connection with conduit 4. The dry and clean, high pressure gaseous phases pass on down conduit 11 into one or more work recovery engines 12 before exiting into conduit 13 at a lower pressure than it entered. Conduit 13 connects pipeline 5 to be comingled with the rest of the production fluids in pipe 5. Each work recovery engine 12 is connected to an electrical generator 14. Electricity produced passes down wire 15 and can be used for any purpose but cleaning the hydrocarbon gas and running sequestration pumps for subsurface disposal of contaminants like carbon dioxide is preferable. The pipeline 5 passes on to an aqueous ammonia cleaning plant 17 in which hydrogen sulphide (H2S) and carbon dioxide are removed from the hydrocarbon gas. An aqueous ammonia cleaning plant 17 functions at a lower pressure than other gas cleaning plants allowing for the generation of more electricity from the process described above.

This entire process from wellhead to end runs at very high pressures, with high temperatures and can contain dangerous gases like H2S, CH4, etc., so safety is paramount. A plethora of control valves, isolation valves, pressure sensors, temperature sensors, level sensors, gas sensors and an emergency shutdown system (and electrification) is essential for safe operation but have been omitted for clarity in the illustrations.

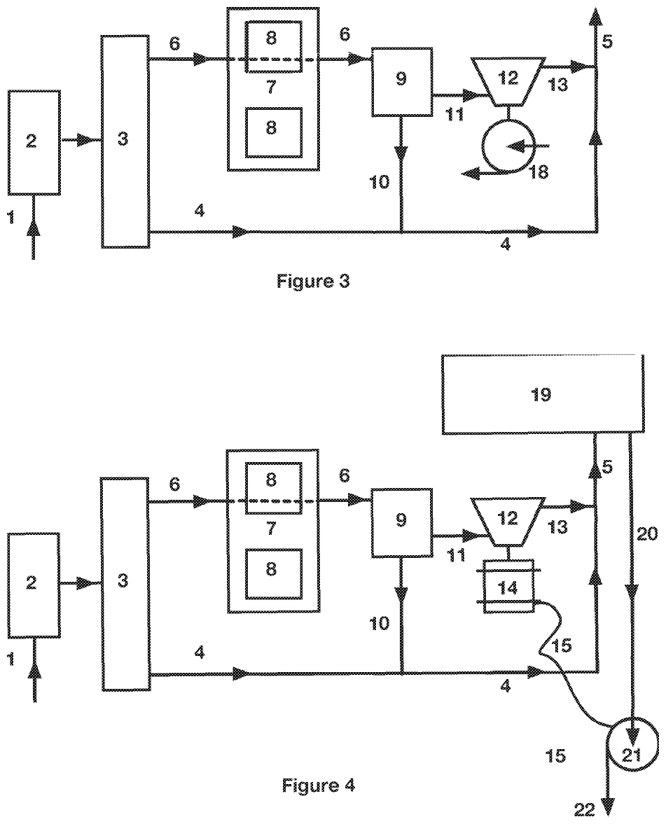

In FIG. 3, high pressure pipeline or 1 which carries the production flow from a gas well or wells drilled into a deep hydrocarbon reservoir, is connected to an overpressure protector 2 that sets the maximum fluid pressure that can pass beyond the protector 2 and limits the pressure to a pressure compatible with the next stages of the process. Overpressure protector 2 is connected by conduit to bulk separator 3 which crudely separates liquid phases from gaseous phases, liquid phases bypass the rest of the system via conduit 4 to be comingled later with the rest of the well production phases in pipeline 5. Gaseous phases pass onwards through conduit 6 into filter system 7 which removes entrained solids and has a plurality of selectable filter units 8 to allow for switching and cleaning without restricting the continuous flow of gaseous phases. The filtered gaseous phases then pass further down conduit 6 to a final separator 9 to ensure the gaseous phases are completely dry. Any liquid phases separated out pass through conduit 10 to eventually connect with pipeline 5, in this illustration via connection with conduit 4. The dry and clean, high pressure gaseous phases pass on down conduit 11 into one or more work recovery engine 12 before exiting into conduit 13 at a lower pressure than it entered. Conduit 13 connects pipeline 5 to be comingled with the rest of the production fluids in pipe 5. Each work recovery engine 12 is connected to a compressor pump 18. Compressor pump 18 can be used pump CO2 and other contaminants into subsurface strata for sequestration or to compress hydrocarbon gas for LPG transportation.

This entire process from wellhead to end runs at very high pressures, with high temperatures and can contain dangerous gases like H2S, CH4, etc., so safety is paramount. A plethora of control valves, isolation valves, pressure sensors, temperature sensors, level sensors, gas sensors and an emergency shutdown system (and electrification) is essential for safe operation but have been omitted for clarity in the illustrations.

In FIG. 4, high pressure pipeline or 1 which carries the production flow from a gas well or wells drilled into a deep hydrocarbon reservoir, is connected to an overpressure protector 2 that sets the maximum fluid pressure that can pass beyond the protector 2 and limits the pressure to a pressure compatible with the next stages of the process. Overpressure protector 2 is connected by conduit to bulk separator 3 which crudely separates liquid phases from gaseous phases, liquid phases bypass the rest of the system via conduit 4 to be comingled later with the rest of the well production phases in pipeline 5. Gaseous phases pass onwards through conduit 6 into filter system 7 which removes entrained solids and has a plurality of selectable filter units 8 to allow for switching and cleaning without restricting the continuous flow of gaseous phases. The filtered gaseous phases then pass further down conduit 6 to a final separator 9 to ensure the gaseous phases are completely dry. Any liquid phases separated out flow down conduit 10 to eventually connect with pipeline 5, in this illustration via connection with conduit 4. The dry and clean, high pressure gaseous phases pass on down conduit 11 into one or more work recovery engines 12 before exiting into conduit 13 at a lower pressure than it entered. Conduit 13 connects pipeline 5 to be comingled with the rest of the production fluids in pipe 5. Each work recovery engine 12 is connected to electrical generator 14. Electricity produced passes down wire 15 and can be used for any purpose but cleaning the hydrocarbon gas and running sequestration pumps for subsurface disposal of contaminants like carbon dioxide is preferable. The pipeline 5 passes on to a cleaning plant 19 in which hydrogen sulphide (H2S) and carbon dioxide are removed from the hydrocarbon gas. Isolated CO2 passes into pipeline 20 and into sequestration pump 21, which can be powered by electricity from generator 14 via wiring 15. CO2 then travels deep underground via well 22.

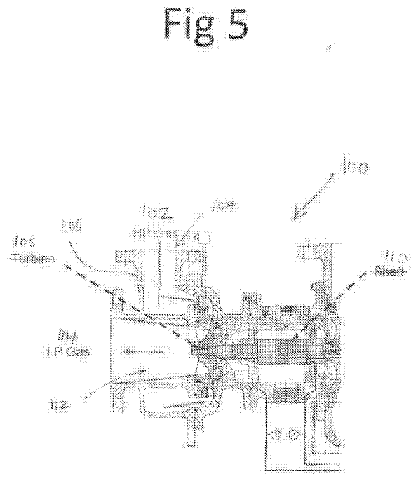

FIG. 5 shows a turbo expander 100 in accordance with the present invention in cross-sectional view. High pressure (HP) gas 102 is fed into the inlet 104 of the body 106 of the turbo expander 100. The turbo expander 100 has a turbine 108 mounted on a shaft 110 which is rotatably housed within the body of the turboexpander. As the HP gas enters the expansion chamber 112 the turbine is rotated which in turn rotates the shaft which can be used to generate electricity, for example. Lower Pressure (LP) gas 114 exits the expansion chamber and the turbo expander.

This entire process from wellhead to end runs at very high pressures, with high temperatures and can contain dangerous gases like H2S, CH4, etc., so safety is paramount. A plethora of control valves, isolation valves, pressure sensors, temperature sensors, level sensors, gas sensors and an emergency shutdown system (and electrification) is essential for safe operation but have been omitted for clarity in the illustrations.

1-19. (canceled)

20. A process for recovering energy in a natural gas production system comprising :
extracting natural gas from a subterranean natural gas reservoir,
passing said gas through an overpressure separator,
separating the liquid and gas phases,
filtering the gas phase stream to remove entrained solids,
drying the gaseous phase,
passing the gaseous phase through a work recovery engine to convert the high pressure, high temperature gaseous phase into lower pressure, lower temperature gaseous phase and thereby generate energy.

21. The process as claimed in claim 20, wherein the subterranean natural gas reservoir comprises a High Pressure High Temperature (HPHT) Acid/Sour gas fields or a sweet gas fields.

22. The process as claimed in claim 21, wherein the subterranean natural gas reservoir has an initial reservoir pressure of about 10,000 psia (690 bara) and reservoir temperature of about 300 oF. (149 oC.).

23. The process as claimed in claim 20, wherein the work recovery engine comprises means to convert changes in pressure into electricity.

24. The process as claimed in claim 20, wherein the work recovery engine comprises a turboexpander.

25. The process as claimed in claim 24, wherein the work created by the turboexpander is used to power a piggy-backed compressor and/or to generate electricity.

26. The process as claimed in claim 20, further comprising the step of pre-treatment to remove solids and/or liquids from the inlet fluid stream.

27. The process as claimed in claim 20, further comprising filtration upstream of the work recovery engine to reduce any contaminant particles to a size of about 2-3 μm in diameter.

28. The process as claimed in claim 20, further comprising the separation of liquids upstream of the work recovery engine to separate and/or reduce the volume of liquid droplets from the feed gas.

29. An energy recovery system comprising
a subterranean natural gas reservoir in fluid communication with an overpressure protector, in fluid communication with a separator for separating liquid phase from gaseous phase;
a filter system for separating entrained solids and comprising at least one filter unit cleaning the gaseous phase;
means for drying the gaseous phase; and
at least one work recovery engine for recovering work from the expansion of the gas phase.

30. The system as claimed in claim 29, wherein the work recovery engine receives high pressure, high temperature fluids and delivers lower pressure, lower temperature fluids downstream and thereby generates energy that can be utilised in other systems.

31. The system as claimed in claim 29, wherein the at least one work recovery engine is coupled to means for making use of the recovered energy.

32. The system as claimed in claim 31, wherein the means for making use of the recovered energy comprises a compressor pump and/or electrical generator

33. The system as claimed in claim 32, wherein the electricity produced may be utilised to clean the hydrocarbon gas and/or powering sequestration pumps for subsurface disposal of contaminants, such as carbon dioxide.

34. The system as claimed in claim 29, wherein the work recovery engine may be in fluid communication with a production fluids conduit such that gaseous phase may be comingled therewith.

35. The system as claimed in claim 34, wherein the comingled gaseous phase and liquid phase may pass to an ammonia cleaning plant in which hydrogen sulphide and carbon dioxide may be removed from the hydrocarbon gas phase.

36. The system as claimed in claim 29, wherein the work recovery engine is coupled to a compressor pump to provide energy thereto and which may operate to pump carbon dioxide and/or other contaminants into substrata for sequestration or to compress hydrocarbon gas for LPG transportation.

37. The system as claimed in claim 29, wherein the work recovery engine is coupled to a cleaning plant in which hydrogen sulphide and carbon dioxide may be removed from the hydrocarbon gas phase.

38. The system as claimed in claim 37, wherein the carbon dioxide is isolated and delivered to a sequestration pump which may itself be powered by electricity provided by an electricity generator upstream.
